(19) United States
(12) Patent Application Publication
(10) Pub. No.: US 2010/0283975 A1
(43) Pub. Date: Nov. 11, 2010

(54) DISPLAY APPARATUS

(75) Inventors: Chien-Chih HSIUNG, Taichung (TW); Yu-Hsiang HUANG, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/765,044

(22) Filed: Apr. 22, 2010

(30) Foreign Application Priority Data
May 8, 2009 (TW) 98115428

(51) Int. Cl. G03B 21/00

(52) U.S. Cl. 353/33; 353/31

(57) ABSTRACT

A display apparatus comprises a light module and an optical engine. The light module has a plurality of lighting members that emit light beams with single wavelengths, and a wavelength transfer device with different fluorescent matters. When the light beams emitted from the lighting members pass through the fluorescent matter, the light beams become visible light beams with different wavelengths. The optical engine at least has one micro-displaying member. When a visible light beam enters the optical engine, it is emitted through the micro-displaying member and generates an imaging light beam. Finally, the imaging light beam is emitted on a screen.

### CROSS REFERENCE TO RELATED APPLICATIONS

This application claims priority of Taiwan Patent Application No. 98115428, filed on May 8, 2009, the entirety of which is incorporated by reference herein.

### BACKGROUND OF THE INVENTION

1. Field of the Invention

The present invention corresponds to a display apparatus, and in particular corresponds to a display apparatus having a wavelength transfer device.

2. Description of the Related Art

A laser beam has high-directional character, high-brightness character and monochromaticity. Due to its characteristics, a laser beam can be used as a light source for a display apparatus.

Referring to FIG. 1, which is a schematic view illustrating a laser beam as a light source of a conventional display apparatus. The display apparatus comprises a light module 10, an optical engine 20, and a screen 30.

The light module 10 comprises a red laser source 11, a green laser source 12 and a blue laser source 13. The green laser source 12 is an SHG laser. The laser sources 11, 12, 13 are visible light. The red laser source 11 emits red light, the green laser source 12 emits green light, and the blue laser source 13 emits blue light. Visible lights of different colors are generated by red light, green light, and blue light (RGB).

The optical engine 20 has a first collimating lens 211, a second collimating lens 212 and a third collimating lens 213, wherein the first collimating lens 211 corresponds to the red laser source 11, the second collimating lens 212 corresponds to the green laser source 12, and the third collimating lens 213 corresponds to the blue laser source 13. The optical engine 20 has a first spectroscope 221, a second spectroscope 222 and a third spectroscope 223. The first spectroscope 222 corresponds to the red laser source 11, the second spectroscope 222 corresponds to the green laser source 12, and the third spectroscope 223 corresponds to the blue laser source 13. The spectroscopes 221, 222, 223 all tilt to a same angle to compound different optical paths into an optical path. The optical engine 20 has a light beam changing member 23 for changing the form of a light beam, wherein the light beam changing member 23 and the compounding optical path are on the same line. The optical engine 20 has a prism 24. The prism 24 is a polarized beam-splitter for separating a P light beam and an S light beam. The optical engine 20 has a micro-displaying member 25 which can be a Micro Electro Mechanical Systems (MEMS), Liquid Crystal On Silicon (LCOS), Liquid Crystal Display (LCD) or Digital Light Processing (DLP). In FIG. 1, a LCOS as used as an example. The optical engine 20 has a lens 26.

The screen 30 projects the image from the lens 26.

When the switch of the display apparatus 1 turns on, the red laser source 11, the green laser source 12 and the blue laser source 13 of the light module 10 receive a signal to differentiate which laser source needs to be turned on. Referring to FIG. 1, the red laser source 11, the green laser source 12 and the blue laser source 13 are turned on, so the red laser source 11 emits a red light beam, the green laser source 13 emits a green light beam, and the blue laser source 13 emits a blue light beam. The red light beam is emitted through the first spectroscope 221, and then is reflected to the second spectroscope 222. The green light beam is emitted through the second spectroscope 222, and then is mixed with the red light beam to generate a yellow light beam. The blue light beam is emitted through the third spectroscope 223, and then is mixed with the yellow light beam to generate a white light beam. After that, the white light beam is emitted through the light beam changing member 23 and the prism 24, to the micro-displaying member 25, is reflected to the prism 24, and then is emitted to the lens 26. The lens 26 projects an image on the screen 30.

Note that the red, green and blue laser sources 11, 12, 13 can be activated at the same time or not and in various sequences. Also, the optical engine 20 does not always emit a white light beam.

However, further decreasing cost of the light source of a conventional display apparatus is hindered, due to the relatively high cost for the SHG laser of the green laser beam.

### BRIEF SUMMARY OF THE INVENTION

The display apparatus comprises a light module and an optical engine. The light module has a plurality of lighting members that emit light beams with single wavelengths, and a wavelength transfer device with different fluorescent matters. When the light beams emitted from the lighting members pass through the fluorescent matter, the light beams become visible light beams with different wavelengths. The optical engine at least has one micro-displaying member. When a visible light beam enters the optical engine, it is emitted through the micro-displaying member and generates an imaging light beam. Finally, the imaging light beam is emitted on a screen.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional display apparatus;

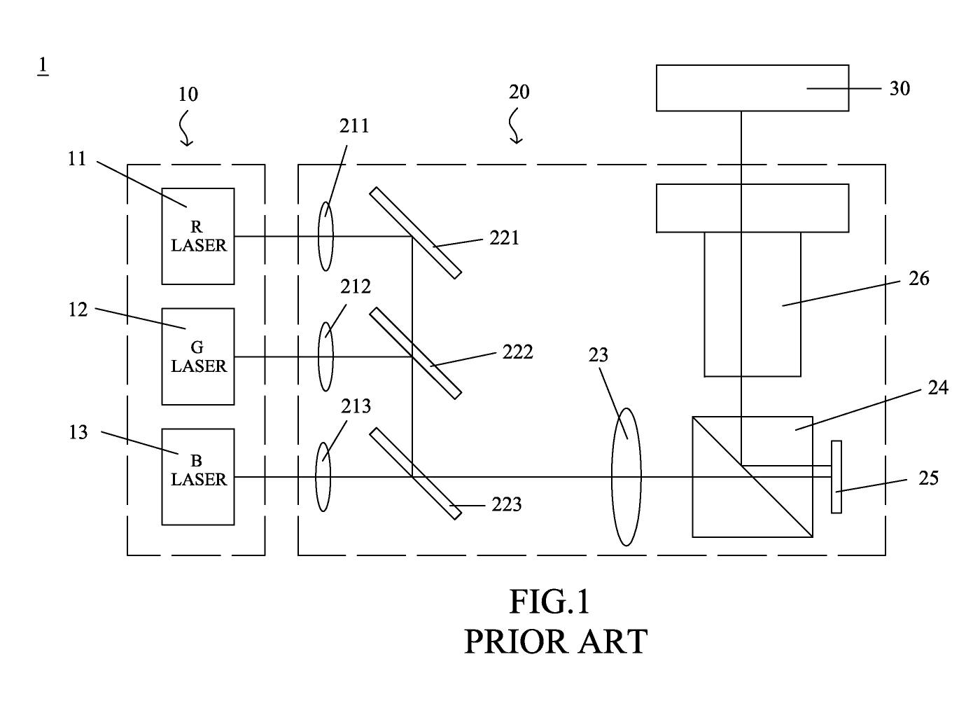

FIG. 2 is a schematic view of a preferred embodiment of a display apparatus of the invention.

### DETAILED DESCRIPTION OF THE INVENTION

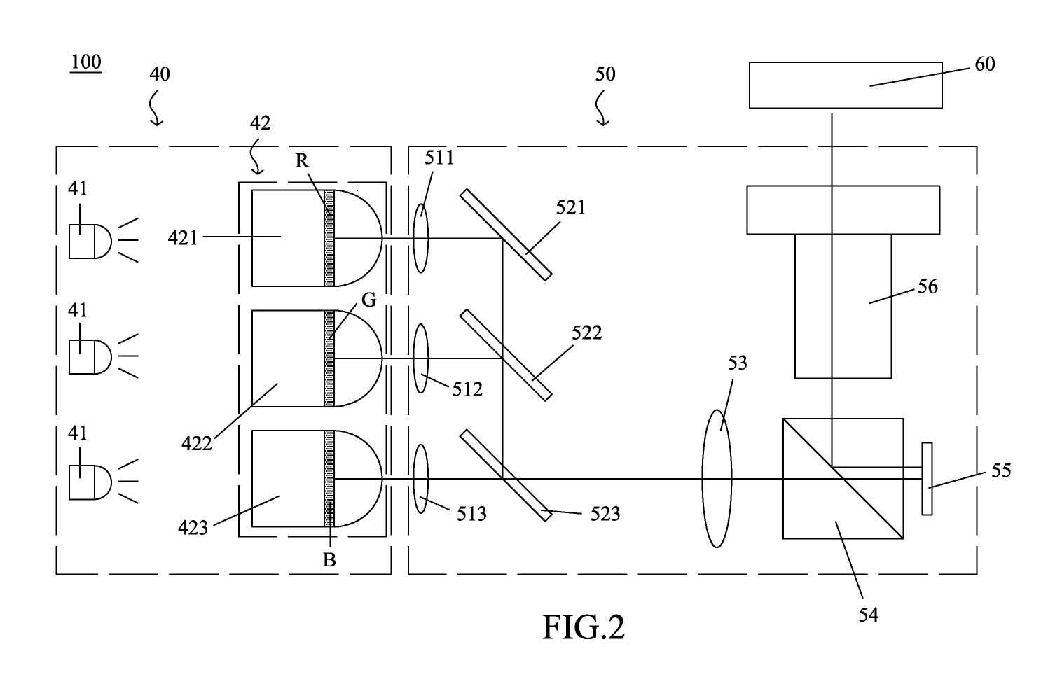

Referring to FIG. 2, a schematic view of a preferred embodiment of a display apparatus of the invention is provided. The display apparatus comprises a light module 40, an optical engine 50 and a screen 60.

The light module 40 has plurality of lighting members 41 which emit UV laser beams. The UV laser beam is a single wavelength laser beam and invisible laser beam. The light module 40 has a wavelength transfer device 42 comprising a first transfer unit 421, a second transfer unit 422 and a third transfer 423, with different fluorescent matters respectively. The first transfer unit 421 has red fluorescence powder R, the second transfer unit 422 has green fluorescence powder G, and the third transfer unit 423 has blue fluorescence powder B. The lighting members 41 emit red, green and blue light when respectfully passing through the red fluorescence powder, the green fluorescence powder and the blue fluorescence powder.

The optical engine 50 has a first collimating lens 511, a second collimating lens 512 and a third collimating lens 513. The first collimating lens 511 corresponds to the red fluorescence powder R, the second collimating lens 512 corresponds to the green fluorescence powder G, and the third collimating lens 513 corresponds to the blue fluorescence powder B. The optical engine 50 has a first spectroscope 521, a second spectroscope 522 and a third spectroscope 523 which the first spectroscope 521 corresponds to the red fluorescence R, the second spectroscope 522 corresponds to the green fluorescence powder G, and the third spectroscope 523 corresponds to the blue fluorescence powder B. The spectroscopes 521, 522, 523 all tilt to a same angle for compounding different optical paths into an optical path. The optical engine 50 has a light beam changing member 53, for changing forms of a light beam, and the light beam changing member 53 and the compounding optical path are on the same line. The optical engine 50 has a prism 54, which is a polarized beam-splitter for separating a P light beam and an S light beam. The optical engine 50 has a micro-displaying member 55 which can be a Micro Electro Mechanical Systems (MEMS), Liquid Crystal On Silicon (LCOS), Liquid Crystal Display (LCD) or Digital Light Processing (DLP). In this invention, An LCOS is used as an example. The optical engine 50 has a lens 56.

The screen 60 projects the image from the lens 56.

When a switch of the display apparatus 100 is turned on, the light members 41 of the light module 40 receive signals to emit or not emit light beams. Then, the light beams pass through the wavelength device 42. Referring to FIG. 2 as an example, because the first transfer unit 421 has red fluorescence powder R, the second transfer unit 422 has green fluorescence powder G, and the third transfer unit 423 has blue fluorescence powder B, the light passing through the first transfer unit 421 becomes red light, the light passing through the second transfer unit 422 becomes green light, and the light passing through the third transfer unit 423 becomes blue light. The red light beam is emitted through the first spectroscope 521, and then is reflected to the second spectroscope 522. The green light beam is emitted through the second spectroscope 522, and then is mixed with the red light beam to generate a yellow light beam. The blue light beam is emitted through the third spectroscope 523, and then is mixed with the yellow light beam to generate a white light beam. After that, the white light beam is emitted through the light beam changing member 53 and the prism 54, to the micro-displaying member 55, is reflected to the prism 54, and then is emitted to the lens 56. The lens 56 projects an image on the screen 60.

Note that the light members 41 can be activated at the same time or not and in various sequences. Also, the optical engine 50 does not always emit a white light beam.

Because the light sources of the light members in this invention are the same, an SHG laser is not required as in prior art, thus costs can be decreased.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A display apparatus, comprising:
a light module, including a plurality of lighting members that emit light beams with single wavelengths, and a wavelength transfer device, wherein the wavelength transfer device has different fluorescent matters for transferring the single wavelength laser beam light to visible light of different wavelengths; and
an optical engine, including a micro-displaying member, wherein, when the visible light of different wavelengths is emitted through the optical engine, the image is projected on a screen by the micro-displaying member.

2. The display apparatus as claimed in claim 1, wherein the single wavelength laser beam emitted from the lighting members is UV laser beam.

3. The display apparatus as claimed in claim 1, wherein the single wavelength laser beam is between a short UV laser beam and a blue ray laser beam.

4. The display apparatus as claimed in claim 1, wherein the wavelength transfer device has a first transfer unit, a second transfer unit and a third transfer unit with red fluorescence powder, green fluorescence powder and blue fluorescence powder respectively.

5. The display apparatus as claimed in claim 1, wherein the optical engine further has a collimating lens, a spectroscope, a light beam changing member and a prism.

6. The display apparatus as claimed in claim 5, wherein the optical engine further has a lens.

7. The display apparatus as claimed in claim 1, wherein the micro-displaying member is a Micro Electro Mechanical Systems (MEMS), Liquid Crystal On Silicon (LCOS), Liquid Crystal Display (LCD) or Digital Light Processing (DLP).
